(19) United States
(12) Patent Application Publication
(10) Pub. No.: US 2017/0246586 A1
(43) Pub. Date: Aug. 31, 2017

(54) PROCESS AND APPARATUS FOR SEPARATING ENTRAINED AMINES FROM A GAS STREAM

(71) Applicant: Carbonoro B.V., Nijmegen (NL)

(72) Inventor: Immanuel Jurg, Nijmegen (NL)

(21) Appl. No.: 15/521,862

(22) PCT Filed: Oct. 27, 2015
(86) PCT No.: PCT/NL2015/050743

§ 371 Date: Apr. 25, 2017

(30) Foreign Application Priority Data
Oct. 27, 2014 (EP) 14190446.6

(51) Int. Cl. B01D 53/14; F23J 15/04

(52) U.S. Cl. CPC B01D 53/1425; B01D 53/1462; F23J 15/04; B01D 2252/20426; B01D 2252/20431; B01D 2252/20436; F23J 2219/40

(57) ABSTRACT

This disclosure relates to a process for removing acid gases from a gas stream enriched in acid gases, wherein: (a) the gas stream enriched in acid gases is contacted in an absorption zone with an absorption medium, wherein the absorption medium is an aqueous medium comprising an amine, to form a gas stream depleted in acid gases which comprises an entrained amine and an absorption medium enriched in acid gases; and (b) treating the gas stream depleted in acid gases which comprises an entrained amine in a scrubbing zone with a scrubbing medium, wherein the scrubbing medium is an aqueous medium comprising an amine, the amount of amine comprised by the scrubbing medium being about 0 to about 10.0 wt. %, to form a gas stream depleted in acid gases and in amine and a scrubbing medium enriched in amine.

### CROSS-REFERENCE TO RELATED APPLICATIONS

This application is a national phase entry under 35 U.S.C. §371 of International Patent Application PCT/NL2015/050743, filed Oct. 27, 2015, designating the United States of America and published in English as International Patent Publication WO 2016/068698 A1 on May 6, 2016, which claims the benefit under Article 8 of the Patent Cooperation Treaty to European Patent Application Serial No. 14190446.6, filed Oct. 27, 2014.

### TECHNICAL FIELD

This application relates to a process for separating entrained amines from a gas stream, in particular biogas and flue gas. The disclosure also relates to an apparatus for performing such a process.

### BACKGROUND

Post-combustion processes for removing acid gases, in particular carbon dioxide and hydrogen sulfide, from gas streams are known in the art. In a typical process, a gas stream enriched in acid gases is contacted (usually countercurrently) in an absorption column with an absorption medium which absorbs the acid gases. The gas stream depleted in acid gases leaves at the top of the absorption column. The absorption medium enriched in acid gases is subsequently fed to a stripper column where it is contacted (usually countercurrently) with a stripping agent (usually steam) to strip the acid gases from the absorption medium enriched in acid gases. The acid gases leave at the top of the stripper column and the stripped absorption medium is returned to the absorption column. Reference is made to the prior art cited in this document.

A common absorption medium is an aqueous stripping agent comprising an alkanolamine, e.g. monoethanolamine (MEA) and methyldiethanolamine (MDEA), or an amine, e.g. pentyl amine and dibutylamine. Alkanolamines have generally a higher boiling point than amines. The amine may be a primary, a secondary or a tertiary amine. Mixtures of alkanolamines and/or amines have been employed as well. Reference is made to U.S. Pat. No. 7,074,258, incorporated by reference.

In the absorption column, primary and secondary amines react with carbon dioxide to carbamates:

2 RNH₂+CO₂→RNH₃⁺RNHCO₂⁻

2 R₂NH+CO₂→R₂NH₂⁺R₂NCO₂⁻

Tertiary amines react with carbon dioxide to carbonates:

R₃N+CO₂+H₂O→R₃N⁺HCO₃⁻

Hydrogen sulfide reacts in a similar fashion:

RNH₂+H₂S→RNH₃⁺HS⁻

R₂NH+H₂S→R₂NH₂⁺HS⁻

R₃N+H₂S→R₃NH⁺HS⁻

These reactions are reversed at elevated temperatures, i.e. in the stripper column. These reactions and their kinetics are for example discussed in U.S. Pat. No. 7,601,315, incorporated by reference.

Carbamates, carbonates and similar products have usually a higher water solubility than the amines.

The aqueous stripping agent usually comprises about 20 wt. % to about 50 wt. % of amine, based on the total weight of the aqueous stripping agent.

The stripping of absorption medium enriched in acid gases has a high energy consumption, i.e. that it must be performed at elevated temperature (>100° C.). One approach to reduce this high energy consumption is to employ an aqueous stripping agent comprising a lipophilic amine that is capable to induce a phase separation resulting in the formation of an aqueous phase and a non-aqueous phase, the latter comprising predominantly the lipophilic amine. In this way, the temperature for stripping could be reduced to less than about 80° C. Preferred lipophilic amines include N,N-dimethylcyclohexylamine (DMCA) an N-methylcyclohexylamine (MCA). Reference is made to J. Zhang et al., Chem. Eng. Technol. 34, 1481, 2011; J. Zhang et al., Chem. Eng. Res. Des. 90, 743, 2012; U.S. Patent Publication No. 2010/288126, all incorporated by reference. Another approach is to use diamines. Reference is made to U.S. Patent Publication No. 2013/011314, incorporated by reference.

The process described above has as a disadvantage that the gas stream depleted in acid gases that is formed in the absorption column contains small amounts of the active components of the absorption medium (i.e. lipophilic amine) and/or basic degradation products. In particular amines are entrained in the gas stream because of their relatively low volatility (amine slip). This is undesired for various reasons.

First, if the gas stream enriched in acid gases is a flue gas, the treated flue gas as well as the amines are released to the atmosphere. However, amines in particular have an unpleasant odour and are poisonous and are therefore undesired components in the environment.

Second, if the gas stream enriched in acid gases is synthesis gas, the amines may be poisonous for catalysts.

Additionally, if the gas stream enriched in acid gases is biogas (a biogas is a gas that is formed by aerobic digestion of biodegradable products, e.g. agricultural products, food industry waste, residues and waste materials of vegetable and/or animal origin, including sewage and landfill gases, and consist mainly of methane and carbon dioxide; the carbon dioxide content may be 30%-50% by volume), the treated biogas is intended to be used as a fuel source and the odour of the amines will mask the smell of the odorant which is usually added as a safety measure (methane itself is odourless).

Furthermore, any amine loss has to be compensated which increases operational costs.

U.S. Pat. No. 6,117,404, incorporated by reference, discloses that the gas stream depleted in acid gases is brought into vapour-liquid contact with water in an amine recovering unit at a temperature of 20° to 60° C. to remove entrained amines. The amines are alkanolamines, methylpyrollidone, amino acids and mixtures thereof. These amines are relatively hydrophilic and have a relatively low log P (typically less than −0.5). The water containing the recovered amines is reused in the process.

U.S. Pat. No. 7,601,315, incorporated by reference, discloses that the gas stream depleted in acid gases may be washed with water in for example a packed section which is part of the absorption column. The water may be make-up water that is introduced in the process or it is a part of a condensate stream formed in the upper part of the stripper column.

U.S. Pat. No. 8,523,979, incorporated by reference, discloses a process for removing carbon dioxide from flue gas, wherein the flue gas is treated with an absorption liquid to produce a flue gas depleted in carbon dioxide. The absorption liquid comprises an amine, a stripping aid and water. The amine comprises preferably a primary or a secondary amine such as alkanolamines, diamines and piperazines which all have a relatively low log P (typically less than −0.5). The stripping aid is a water-miscible liquid having a boiling point at atmospheric pressure below 100° C., in particular alcohols, ethers and ketones. The flue gas depleted in carbon dioxide is treated with a liquid aqueous phase, in particular water, to remove entrained stripping aid in a scrubbing column located on top of the absorption column. It is further disclosed that the liquid aqueous phase may comprise amine.

U.S. Patent Publication No. 2011/308389, incorporated by reference, discloses a process for eliminating the emission of amines and basic degradation products in a plant for carbon dioxide capture from flue gas, wherein the flue gas depleted from carbon dioxide is washed with an acidic aqueous solution.

U.S. Pat. No. 8,529,857, incorporated by reference, discloses a process for removing carbon dioxide from flue gas, wherein the flue gas is treated with an absorption medium to produce a flue gas depleted in carbon dioxide. The absorption medium comprises an aqueous solution comprising an amine. The amine is preferably an amine as disclosed in U.S. Pat. No. 8,523,979, i.e. that the amine has a relatively low log P (typically less than −0.5). The flue gas depleted in carbon dioxide is treated in at least two scrubbing zones with a non-acidic aqueous phase to remove entrained amine or decomposition products thereof. Generally, the pH of the non-acidic aqueous phase is 7 to 11, preferably 8 to 10.

U.S. Patent Publication No. 2014/0060328, incorporated by reference, discloses a process for removing acidic components from a gaseous effluent in an absorption section by using an aqueous solution comprising amines and amine degradation inhibiting compounds. The amines are selected from alkanolamines or aminoalkanols (which have a relatively low log P) or diisopropylamine (log P (calculated; XLOGP3)=1.4), preferably monoethanolamine (log P (calculated; XLOGP3)=-1.3). The amine degradation inhibiting compounds are triazole or tetrazole compounds having a substituent comprising a sulphur atom. The purified gaseous effluent depleted in acidic components is washed in a wash section with water to remove entrained amines thereby forming an amine-laden water stream which can be used for several purposes in the process, i.e. it can be recycled to the wash section or to the absorption section or it can be mixed with a gas stream effluent from a regeneration column.

U.S. Patent Publication No. 2012/0234177, incorporated by reference, discloses a process for removing carbon dioxide from a carbon dioxide containing gas stream, e.g. a flue gas, wherein the carbon dioxide containing gas stream is contacted in counter current flow with a carbon dioxide absorbent wherein an amine-based solution is utilized. The purified gas stream is washed in a cleaning section with water comprising the carbon dioxide absorbent to remove carbon dioxide absorbent entrained by the purified gas stream thereby forming a water stream comprising the carbon dioxide absorbent. This water stream is heat-exchanged with the carbon dioxide containing gas stream and then supplied to a regeneration column.

U.S. Patent Publication No. 2014/0013945, incorporated by reference, discloses a process for removing carbon dioxide from a carbon dioxide containing flue gas by contacting the flue gas with a carbon dioxide absorbent which utilizes for example an alkanolamine (which have a relatively low log P) as a base. The purified flue gas is washed in a washing unit with a water stream comprising the carbon dioxide absorbent. This water stream originates from the bottom portion of the washing unit.

U.S. Patent Publication No. 2011/0158891, incorporated by reference, discloses a process for removing carbon dioxide from a carbon dioxide containing flue gas by contacting the flue gas with a carbon dioxide absorbent comprising a basic amine. The purified flue gas is washed in a washing unit with a water stream comprising the carbon dioxide absorbent. This water stream originates from the bottom portion of the washing unit.

However, there is still a need in the art for an improved scrubbing process.

### BRIEF SUMMARY

This disclosure relates to a process for separating entrained amines from a gas stream. In particular, the disclosure relates to a process for removing acid gases from a gas stream enriched in acid gases, wherein:
(a) the gas stream enriched in acid gases is contacted in an absorption zone with an absorption medium, wherein the absorption medium is an aqueous medium comprising an amine, to form a gas stream depleted in acid gases which comprises an entrained amine and an absorption medium enriched in acid gases; and
(b) treating the gas stream depleted in acid gases which comprises an entrained amine in a first scrubbing zone with a first scrubbing medium, wherein the first scrubbing medium is an aqueous medium comprising an amine, the amount of amine comprised by the scrubbing medium being about 0 to about 10.0 wt. %, to form a first gas stream depleted in acid gases and in amine and a first scrubbing medium enriched in amine.

### BRIEF DESCRIPTION OF THE DRAWINGS

FIG. 1 shows a schematic diagram of an embodiment of the process according to the disclosure.

FIG. 2 shows a schematic diagram of another embodiment of the process according to the disclosure.

### DETAILED DESCRIPTION

The verb “to comprise” and its conjugations as used in this description and in the claims are used in their non-limiting sense to mean that items following the word are included, but items not specifically mentioned are not excluded.

In addition, reference to an element by the indefinite article “a” or “an” does not exclude the possibility that more than one of the element is present, unless the context clearly requires that there is one and only one of the elements. The indefinite article “a” or “an” thus usually means “at least one.”

### Scrubbing Medium

According to this disclosure, the first scrubbing medium is an aqueous medium which comprises an amine in an amount of about 0 to about 10.0 wt. %, based on the total weight of the aqueous medium. Preferably, the aqueous medium comprises an amine in an amount of at least about 0.1 wt. %, more preferably about 0.2 wt. %. Preferably, the aqueous medium comprises an amine in an amount of about 6.0 wt. % or less, more preferably about 4.0 wt. % or less, even more preferably about 2 wt. % or less and most preferably in amount of about 1 wt. % or less.

It is preferred that the first scrubbing medium is in the liquid state.

Preferably, the first scrubbing medium has a pH in the range of about 7 to about 11, more preferably about 7 to about 10 and most preferably about 8 to about 10.

The term “amine” is to be understood as a hydrocarbon containing at least an amino group. The amino group may be primary, secondary or tertiary. The hydrocarbon may be substituted by a functional group, in particular a hydroxy group. The hydrocarbon may be saturated or unsaturated, but is preferably saturated. The hydrocarbon may be linear, branched or cyclic.

According to a preferred embodiment of this disclosure, the term “amine” is to be understood as monoamines, i.e. that they have the general formula R₃N, wherein R represents a hydrogen atom or an alkyl group.

According to a preferred embodiment of this disclosure, the amine has preferably a partition coefficient log P of more than −0.5, more preferably of more than 0, even more preferably more than 0.5 and in particular more than 1. The partition coefficient log P is preferably not higher than 3, more preferably not higher than 2.5.

The log P values disclosed in this document are the values computed with the XLOGP3 method (cf. T. Cheng et al., J. Chem. Inf. Model. 47, 2140, 2007; XLOGP3 v 3.2.0 User Manual, Shanghai Institute of Organic Chemistry, Chinese Academy of Sciences, 354 Fenglin Road, Shanghai 200032, China, P. R., Dec. 2007). This method provides accurate results. For example, cyclohexylamine has a measured log P of 1.49±0.10 (J. Sangster, J. Phys. Chem. Ref. Data 18, 111, 1989) and a calculated log P (XLOGP3) of 1.5.

It is preferred that the amine is selected from the group consisting of primary amines, secondary amines, tertiary amines and mixtures thereof. These amines are preferably C₃-C₂₀ alkyl amines, more preferably C₃-C₁₆ alkyl amines, wherein the alkyl groups may be linear, branched or cyclic. Preferably, the amine is selected from the group consisting of secondary amines, tertiary amines and mixtures thereof.

Suitable examples of primary amines include n-pentylamine, n-hexylamine, n-heptylamine, n-octylamine, n-nonylamine, cyclopentylamine, cyclohexylamine, cycloheptylamine, cyclooctylamine, 2-methylcyclohexyl amine, 2-methyl-butylamine, 2-ethyl-1-hexylamine, 6-methyl-2-heptylamine and their skeletal isomers and regioisomers.

Suitable examples of secondary amines include dipropylamine, N-ethylbutylamine, dibutylamine, diisopropylamine, methylcyclohexylamine, dicyclohexylamine, bis(2-ethylhexyl)amine, bis(1,3-dimethylbutyl)amine, di-s-butylamine, N-methylcyclohexylamine, bis(2-ethylhexyl)amine, 4-t-butylcyclohexylamine and their skeletal isomers and regioisomers.

Suitable examples of tertiary amines include triethylamine, tripropylamine, tributylamine, N,N-dimethylcyclohexylamine, dimethyloctylamine, dimethyl-(1-methylheptyl)amine, N-ethyldiisopropylamine, tris(2-ethylhexyl)amine and their skeletal isomers and regioisomers.

Suitable examples of amines containing a functional group, in particular a hydroxy group, are alkanolamines such as monoethanolamine (MEA) and methyldiethanolamine (MDEA) and their skeletal isomers and regioisomers.

Skeletal isomers are compounds wherein the carbon skeleton is reordered. For example, skeletal isomers of n-pentylamine include 1,1-dimethyl-propylamine.

Regioisomers are compounds wherein the functional substituent is attached to a different atom of the carbon skeleton. For example, regioisomers of n-pentylamine include 2-aminopentane.

It is preferred that the amine comprises a cyclic group (i.e. that the amine is a cyclic amine) which may include the nitrogen atom. This implies that the amine may constitute a pyrrolidinyl group or a piperidinyl group.

Most preferably, the amine is N,N-dimethylcyclohexylamine (DMCA), N-methylcyclohexylamine (MCA) or a combination thereof. DMCA has a (calculated; XLOGP3) log P of about 1.9 and MCA has a (calculated; XLOGP3) log P of about 1.6.

According to this disclosure, the scrubbing medium can also be used for scrubbing the carbon dioxide which is released by a regeneration unit (described below).

### Process

According to this disclosure, it is preferred that step (b) is performed countercurrently.

According to this disclosure, it is preferred that the first scrubbing zone is a packed column.

According to this disclosure, it is also preferred that the first scrubbing medium originates from a regeneration unit.

According to the disclosure, it is furthermore preferred that the first scrubbing medium enriched in amine is returned to a regeneration unit.

Preferably, the acid gases are carbon dioxide, hydrogen sulphide or a mixture thereof.

According to this disclosure, the gas stream enriched in acid gases is a biogas. Biogas is a gas that is formed by aerobic digestion of biodegradable products, e.g. agricultural products, food industry waste, residues and waste materials of vegetable and/or animal origin, including sewage and landfill gases, and consists mainly of methane and carbon dioxide; the carbon dioxide content may be 30%-50% by volume.

According to a preferred embodiment, the process according to the disclosure comprises also a step (c), step (c) comprising treating the first gas stream depleted in acid gases and in amine in a second scrubbing zone with a second scrubbing medium, wherein the second scrubbing medium is an aqueous medium comprising an amine, the amount of amine comprised by the second scrubbing medium being about 0 to about 10.0 wt. %, to form a second gas stream depleted in acid gases and in amine and a second scrubbing medium enriched in amine.

According to this preferred embodiment, the second scrubbing medium is an aqueous medium which preferably comprises an amine in an amount of at least about 0.1, more preferably about 0.2 wt. %. Preferably, the aqueous medium comprises an amine in an amount of about 6.0 wt. % or less, more preferably about 4.0 wt. % or less, even more preferably about 2 wt. % or less and most preferably in amount of about 1 wt. % or less. Accordingly, this disclosure includes a process comprising two scrubbing steps, e.g. scrubbing with a first scrubbing medium comprising amine and subsequent scrubbing with water as a second scrubbing medium. Hence, the second scrubbing medium may have a pH in the range of about 7 to about 11, but also in the range of about 7 to about 10 or in the range of about 8 to about 10.

It is preferred that the first scrubbing medium is in the liquid state.

According to this disclosure, it is preferred that the second scrubbing zone is a packed column.

According to this disclosure, it is also preferred that the second scrubbing medium originates from a regeneration unit.

According to this disclosure, it is furthermore preferred that the second scrubbing medium enriched in amine is returned to a regeneration unit.

Furthermore, the amine is selected from the group of monoamines as described previously.

Additionally, it is preferred that the first and/or second scrubbing steps (b) and (c) are independently performed over a temperature range of about 1° C. to about 50° C., preferably about 5° C. to about 40° C. Accordingly, the disclosure includes a process comprising two scrubbing steps, wherein the two scrubbing steps (b) and (c) are performed within a different temperature range, e.g. step (b) is performed within a temperature range of about 20° C. to about 50° C. and step (c) is performed within a temperature range of about 1° C. to less than about 20° C. This disclosure also includes a process comprising two scrubbing steps, wherein the two scrubbing steps (b) and (c) are performed at a same temperature range, e.g. steps (b) and (c) are both performed within a temperature range of about 20° C. to about 50° C. or within a temperature range of about 1° C. to less than about 20° C.

According to another preferred embodiment, the first and/or the second scrubbing medium enriched in amine are subjected to a separation process. In this separation process, when the amine has a partition coefficient log P of more than −0.5, the first and/or the second scrubbing medium enriched in amine is heated to a temperature in the range of about 40° to about 90° C. which results into the formation of an aqueous phase depleted in amine and a non-aqueous phase enriched in amine, where after the two phases are separated. When the amine has a partition coefficient log P of −0.5 or less, the separation process may be conducted with a membrane.

### Apparatus

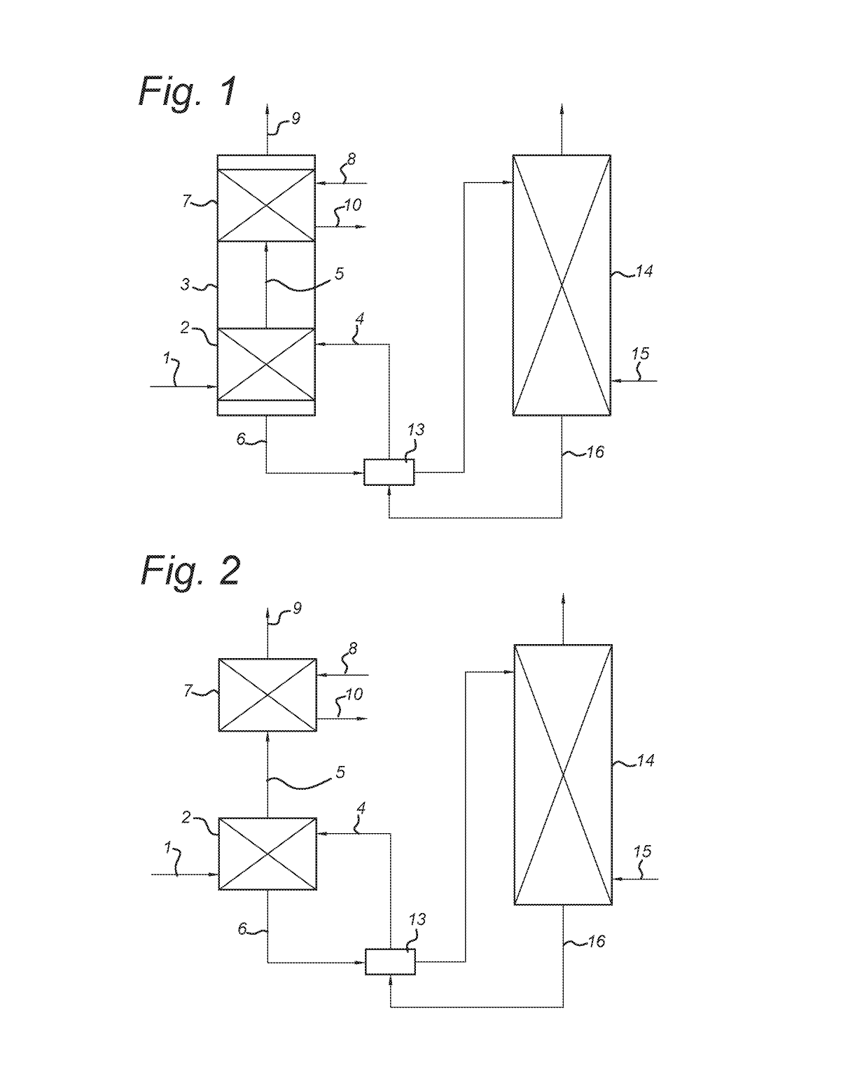

The disclosure also relates to an apparatus for performing the process according to this disclosure. FIG. 1 shows a schematic diagram of this process.

A gas stream (1) enriched in acid gases is supplied to a carbon dioxide absorbing unit (2) comprising an absorption zone. The carbon dioxide absorbing unit (2) is located in the lower part of a carbon dioxide removal unit (3). An absorption medium (4) is supplied to the upper part of the carbon dioxide absorbing unit (2). The absorption medium (4) absorbs carbon dioxide from gas stream (1) enriched in acid gases thereby forming a gas stream (5) depleted in acid gases which leaves the carbon dioxide absorbing unit (2) at the upper part and an absorption medium (6) enriched in acid gases which leaves the carbon dioxide absorbing unit (2) at the lower part. The gas stream (5) depleted in acid gases comprises entrained amines which have to be removed.

The gas stream (5) depleted in acid gases is supplied to the lower part of a first amine scrubbing unit (7) comprising a first scrubbing zone. As is shown in FIG. 1, the first amine scrubbing unit (7) is located in the upper part of the carbon dioxide removal unit (3). However, according to this disclosure, the carbon dioxide absorbing unit (2) and the first amine scrubbing unit (7) do not need to be part of a single carbon dioxide removal unit (3), i.e. they may be separate units and they may be located remotely (FIG. 2).

A first scrubbing medium (8) is supplied to the upper part of the first amine scrubbing unit (7) to form a first gas stream (9) depleted in acid gases and in amine which leaves the first amine scrubbing unit (7) at the upper part and a first scrubbing medium (10) enriched in amine which leaves the first amine scrubbing unit (7) at the lower part.

The first gas stream (9) depleted in acid gases and in amine may be supplied to a second amine scrubbing unit (11) where it is contacted in a second scrubbing zone with a second scrubbing medium (12) enriched in amine to form a second gas stream (13) depleted in acid gases and in amine and a second scrubbing medium (14) enriched in amine (not shown). The second amine scrubbing unit (11) may be part of a single carbon dioxide removal unit (3) or it may be a separate and remote unit.

The absorption medium (6) enriched in acid gases is supplied to a heat exchanger (13) and then to the upper part of a regeneration unit (14). Steam (15) is supplied to the lower part of regeneration unit (14) and strips absorption medium (6) at elevated temperature to form carbon dioxide which is released at the top of the regeneration unit (14) and absorption medium (16) depleted in acid gases. Absorption medium (16) may be cooled in heat exchanger (13) and then be supplied to the carbon dioxide absorbing unit (2). After cooling, the absorption medium (16) may also be supplied to the first amine scrubbing unit (7) or the second amine scrubbing unit (11).

According to a preferred embodiment of the disclosure, the regeneration unit (14) may also be a stirred tank comprising water wherein the carbon dioxide is removed without steam. This embodiment is in particular preferred when the amine is a lipophilic amine.

First scrubbing medium (10) enriched in amine and optionally second scrubbing medium (14) enriched in amine are reused in the process. For example, they are used for preparing absorption medium (4), first scrubbing medium (8) or second scrubbing medium (12).

### EXAMPLES

DMCA is N,N-dimethylcyclohexylamine.

Molecular weight: 113.2 g/mol.

Water solubility (20° C.): 54 g/l (≈0.48 mol/l).

Boiling point: 160° C.

Log P: 1.9.

MCA is N-methylcyclohexylamine (MCA)

Molecular weight: 127.2 g/mol.

Water solubility (20° C.): 10 g/l (≈0.08 mol/l).

Boiling point: 149° C.

Log P: 1.6.

### Example 1

Aqueous samples containing MCA and/or DMCA were analysed by UPLC-MS/MS. The UPLC apparatus was a Waters ACQUITY° system. Injection volume was 3 μl. Mobile phase A: 10 mM ammonium acetate, 0.1 wt. % formic acid in water. Mobile phase B: methanol. Column: ACQUITY UPLC® HSB T3, 1.8 μ2.1×50 mm. Column temperature: 30° C. Gradient (Table 1). The mass spectrometer was an AB SCIEX™ API 3200 apparatus.

TABLE 1

| Time | Flow | | |
|---|---|---|---|
| (min.) | (ml/min.) | Wt. % A | Wt. % B |
| 0 | 0.6 | 80 | 20 |
| 0.1 | 0.6 | 80 | 20 |
| 1 | 0.6 | 50 | 50 |
| 1.5 | 0.6 | 80 | 20 |
| 2 | 0.6 | 80 | 20 |

Regression analysis of the calibration curve (concentration range MCA or DCMA: 10-200 μg/l) showed a correlation factor of 0.999.

### Example 2

A mixture (200 ml) of MCA and DMCA (total amine concentration is 3 M; ratio MCA:DMCA is 1:3 wt./wt. 1:2.67 mol/mol; total absolute amount MCA is 92.8 g/l; total amount of DMCA is 278.4 g/l) in water was saturated under stirring with carbon dioxide at ambient temperature and atmospheric pressure. During saturation the hazy two-phase solution turned clear. The amount of absorbed carbon dioxide was determined according to a direct Total Inorganic Carbon (TIC) analysis. In this analysis, carbon dioxide was stripped from samples by a nitrogen purge and the stripped carbon dioxide was first trapped in three sequential bottles containing KOH and then in a bottle containing CaCl₂. If not all carbon dioxide would not be trapped by the bottles containing KOH, a white deposit of CaCO₃ would be formed in the bottle containing CaCl₂. However, formation of a white deposit of CaCO₃ was not observed. It turned out that 1 mol of amine absorbed 1 mol of carbon dioxide as expected. Full saturation (100%) was achieved within about one hour.

### Example 3

In this example, the entrainment of amines by a gas in the absorption step was simulated. In a closed system, a mixture (50 ml) of MCA and DMCA (composition according to Example 2) was flushed with nitrogen (34.5 1 N₂/h) for 30 minutes at various temperatures. The amine mixture was preheated to the required temperature 20 minutes before the start of the test. The gaseous effluent was then flushed through three washing bottles in series which were filled with an aqueous 0.01 M formic acid solution to capture the entrained amines. The amount of captured amines in the washing bottles was determined according to the method described in Example 1. The results are shown in Table 2.

TABLE 2

| | | MCA | DMCA | Amines (tot.) |
|---|---|---|---|---|
| Entry | Tₛₜᵣᵢₚ (° C.) | (mol %)^{a} | (mol %) | (mol %) |
| 1 | 25 | 0.30 | 1.02 | 1.33 |
| 2 | 30 | 0.33 | 1.12 | 1.45 |
| 3 | 35 | 0.31 | 1.19 | 1.51 |
| 4 | 40 | 0.34 | 1.22 | 1.56 |
| 5 | 40 | 0.42 | 1.36 | 1.78 |

Entries 4 and 5 show that this simulation is reproducible.

The data in Table 2 show that the amine content of the gaseous effluent decreases with decreasing stripping temperature. The absorption step is therefore preferably performed at low temperature. The data also show that the ratio of MCA:DMCA in the entrained amines is about 1:4.

However, it turned out that much amines condensed in tubing connecting the flask containing the mixture of MCA and DMCA and the first washing bottle filled with formic acid solution. For entry 5, the tubing was rinsed with demineralised water and the amount of amine determined according to the method described in Example 1. The amounts of amines (washing bottles and tubing) are shown in Table 3.

TABLE 3

| | | MCA | MCA | MCA | DMCA | DMCA | DCMA | Amines |
|---|---|---|---|---|---|---|---|---|
| | Tₛₜᵣᵢₚ | (bottles) | (tubing) | (total) | (bottles) | (tubing) | (total) | (tot.) |
| Entry | (° C.) | (mol %)^{a} | (mol %) | (mol %) | (mol %) | (mol %) | (mol %) | (mol %) |
| 5 | 40 | 0.42 | 2.61 | 3.03 | 1.36 | 1.09 | 2.45 | 5.48 |

^{a}relative to total molar amount of MCA and DMCA in mixture.

It appears that about 13% of MCA is captured by the washing bottles and about 87% condenses in the tubing. For DCMA, these numbers are about 55% and 45%, respectively.

Hence, not all of the amine stripped from the flask containing the mixture of MCA and DMCA is captured by the washing bottles.

It further turned out that almost all (usually >95% for MCA and >85% for DMCA) of the captured amine was captured by the first washing bottle.

### Example 4

In this example, the scrubbing of entrained amines by demineralised water (with or without amine) was simulated.

In a closed system, a mixture (50 ml) of MCA and DMCA (composition according to Example 2) was flushed with nitrogen (34.5 1 N₂/h) for 30 minutes at 40° C. as described in Example 3.

The nitrogen gas stream was then scrubbed with demineralised water (100 ml) at 25° C. or with demineralised water (100 ml) which contained 2 wt. % amine (0.4 wt. % MCA; 0.8 g MCA≈7.1 mmol MCA, 1.6 wt. % DMCA; 3.2 g DMCA 25.9 mmol MCA). The gaseous effluent was then flushed through three washing bottles in series which were filled with an aqueous 0.01 M formic acid solution to capture the entrained amines. The amount of captured amines in the washing bottles was determined according to the method described in Example 1. The various amounts of captured amine are shown in Table 4.

TABLE 4

| | MCA | DMCA | Amines (tot.) |
|---|---|---|---|
| Tₛₜᵣᵢₚ (40° C.) | (mol %)^{a} | (mol %) | (mol %) |
| 100% water | 0.07 | 0.47 | 0.54 |
| 100% water | 0.14 | 1.42 | 1.56 |
| (2 wt. % amine) | | | |

^{a}relative to total molar amount of MCA and DMCA in mixture.

The data shown in Table 4 demonstrate that when the nitrogen gas stream is scrubbed with demineralised water, much of the amines are captured (compare Table 2, entries 4 and 5). However, if the demineralised water contained 2 wt. % of amine, hardly any further mine is captured. Accordingly, when a scrubbing solution based on demineralised water and amine is to be used, the amount of amine must be substantially lower than 2 wt. %.

### Example 5

In this example, the scrubbing of entrained amines by demineralised water was simulated.

In a closed system, a mixture (50 ml) of MCA and DMCA (composition according to Example 2) was flushed with nitrogen (34.5 1 N₂/h) for 30 minutes at 40° C. as described in Example 3. The nitrogen gas stream was then mixed with carbon dioxide (3.75 l/h) to a carbon dioxide concentration of 9.8 vol. % to convert entrained MCA and DMCA to MCA-carbamate and DMCA-carbonate.

The nitrogen gas stream was then cooled to 5° C. Formed condensate (MCA-carbamate and DMCA-carbonate) was collected in a flask and the amount of captured amines in the flask was determined according to the method described in Example 1 (MCA-carbamate and DMCA-carbonate are converted to the amine forms during sample preparation). The cooled nitrogen gas stream was scrubbed with demineralised water (200 ml) at 5° C. The amount of amines captured by the scrubbing solution was determined according to the method described in Example 1. The gaseous effluent was then flushed through three washing bottles in series which were filled with an aqueous 0.01 M formic acid solution to capture the entrained amines. The amount of captured amines in the washing bottles was determined according to the method described in Example 1. The tubing was rinsed with demineralised water (see Example 3) and the amount of amine determined according to the method described in Example 1. The various amounts of amine are shown in Table 5.

TABLE 5

| | MCA | DMCA | Amines (tot.) |
|---|---|---|---|
| Tₛₜᵣᵢₚ (40° C.) | (mol %)^{a} | (mol %) | (mol %) |
| Scrubbing | 0.0013 | 0.6794 | 0.6807 |
| solution | | | |
| Washing | 0.0002 | 0.0080 | 0.0082 |
| bottles | | | |
| Condensate | 0.5287 | 0.9407 | 1.4694 |
| (flask and | | | |
| tubing) | | | |

^{a}relative to total molar amount of MCA and DMCA in mixture.

The data shown in Table 5 demonstrate that with cooling of the gas stream most of the amines are captured by the scrubbing solution (compare with Table 2, entries 4 and 5).

### Example 6

In this example, the scrubbing of entrained amines by demineralised water (200 ml) which contained 2 wt. % amine (0.4 wt. % MCA; 0.8 g MCA≈7.1 mmol MCA, 1.6 wt. % DMCA; 3.2 g DMCA≈25.9 mmol MCA) was simulated.

The experiment was performed as described in Example 4. The various amounts of amine are shown in Table 6.

TABLE 6

| | MCA | DMCA | Amines (tot.) |
|---|---|---|---|
| Tₛₜᵣᵢₚ (°40 C.) | (mol %)^{a} | (mol %) | (mol %) |
| Scrubbing solution | 5.87 | 13.07 | 18.94 |
| Washing bottles | 0.00 | 0.15 | 0.15 |
| Condensate (flask | 5.8740 | 13.0657 | 18.9397 |
| and tubing) | | | |

^{a}relative to total molar amount of MCA and DMCA in mixture.

The data shown in Table 6 demonstrate that with cooling of the gas stream most of the amines are captured by the scrubbing solution containing 2 wt. % amine (compare with Table 2, entries 4 and 5).

Further tests have shown that similar results are obtained with scrubbing solutions containing up to 6 wt. % amine.

### Example 7

In this example, the scrubbing of entrained amines by demineralised water was simulated.

In a closed system, a mixture (50 ml) of MCA and DMCA (composition according to Example 2) was flushed with nitrogen (34.5 1 N₂/h) for 30 minutes at 40° C. as described in Example 3. The nitrogen gas stream was then mixed with carbon dioxide (3.75 l/h) to a carbon dioxide concentration of 9.8 vol. % to convert entrained MCA and DMCA to MCA-carbamate and DMCA-carbonate.

The nitrogen gas stream was scrubbed with demineralised water (200 ml) at 5° C. The amount of amines captured by the scrubbing solution was determined according to the method described in Example 1. The gaseous effluent was then flushed through three washing bottles in series which were filled with an aqueous 0.01 M formic acid solution to capture the entrained amines. The amount of captured amines in the washing bottles was determined according to the method described in Example 1. The tubing was rinsed with demineralised water (see Example 3) and the amount of amine determined according to the method described in Example 1. The various amounts of amine are shown in Table 7.

TABLE 7

| | MCA | DMCA | Amines (tot.) |
|---|---|---|---|
| Tₛₜᵣᵢₚ (40° C.) | (mol %)^{a} | (mol %) | (mol %) |
| Scrubbing | 0.035 | 1.212 | 1.248 |
| solution | | | |
| Washing | 0.000 | 0.001 | 0.001 |
| bottles | | | |
| Condensate | 0.582 | 0.857 | 1.439 |
| (tubing) | | | |

^{a}relative to total molar amount of MCA and DMCA in mixture.

Although most of the amine is in the condensate, the data shown in Table 7 demonstrate that without cooling of the gas stream most of the amines are captured by the scrubbing solution since the washing bottles hardly contain any amine (compare with Table 2, entries 4 and 5).

### Example 8

In this example, the scrubbing of entrained amines by demineralised water was simulated.

In a closed system, a mixture (50 ml) of MCA and DMCA (composition according to Example 2) was flushed with nitrogen (34.5 1 N₂/h) for 30 minutes at 40° C. as described in Example 3.

The nitrogen gas stream was scrubbed with demineralised water (200 ml) at 40° C. The amount of amines captured by the scrubbing solution was determined according to the method described in Example 1. The gaseous effluent was then flushed through three washing bottles in series which were filled with an aqueous 0.01 M formic acid solution to capture the entrained amines. The amount of captured amines in the washing bottles was determined according to the method described in Example 1. The tubing of the three washing bottles was rinsed with demineralised water and the amount of amine determined according to the method described in Example 1. The various amounts of amine are shown in Table 8.

TABLE 8

| | MCA | DMCA | Amines (tot.) |
|---|---|---|---|
| Tₛₜᵣᵢₚ (40° C.) | (mol %)^{a} | (mol %) | (mol %) |
| Scrubbing | 0.070 | 1.495 | 1.565 |
| solution | | | |
| Washing | 0.000 | 0.000 | 0.000 |
| bottles | | | |
| Condensate | 0.652 | 0.972 | 1.624 |
| (tubing) | | | |

^{a}relative to total molar amount of MCA and DMCA in mixture.

These data show that in the absence of carbon dioxide amines can be scrubbed by demineralised water.

### Example 9

A mixture (200 ml) of MCA and DMCA (total amine concentration is 3 M; ratio MCA:DMCA is 1:3 wt./wt.≈1:2.67 mol/mol; total absolute amount MCA is 92.8 g/l; total amount of DMCA is 278.4 g/l) in water was heated at various temperatures for 24 h during which phase separation occurred. The phases were separated and the aqueous phase was analysed for determining the amine content. As can be observed from the data in Table 9, the amount of amine decreases with increasing temperature. These data show that the amines can be separated at elevated temperature from the original mixture.

TABLE 9

| Temperature | MCA | DMCA |
|---|---|---|
| (° C.) | (mg/l) | (mg/ml) |
| 40 | 6940 | 7210 |
| 50 | 5630 | 5090 |
| 60 | 5090 | 4200 |
| 70 | 4520 | 3530 |

1. A process for removing acid gases from a gas stream enriched in acid gases, wherein:
(a) the gas stream enriched in acid gases is contacted in an absorption zone with an absorption medium, wherein the absorption medium is an aqueous medium comprising an amine, to form a gas stream depleted in acid gases which comprises an entrained amine and an absorption medium enriched in acid gases; and
(b) treating the gas stream depleted in acid gases which comprises an entrained amine in a first scrubbing zone with a first scrubbing medium, wherein the first scrubbing medium is an aqueous medium comprising an amine, the amount of amine comprised by the scrubbing medium being about 0 to about 10.0 wt. %, to form a first gas stream depleted in acid gases and in amine and a first scrubbing medium enriched in amine;
wherein the amine has a partition coefficient log P of more than −0.5 and wherein the scrubbing medium originates from a regeneration unit.

2. The process according to claim 1, wherein the amount of amine comprised by the scrubbing medium is about 0.1 to about 6.0 wt. %.

3. The process according to claim 1, wherein the scrubbing medium has a pH in the range of about 7 to about 11.

4. The process according to claim 1, wherein step (b) is performed countercurrently.

5. The process according to claim 1, wherein the scrubbing zone is a packed column.

6. The process according to claim 1, wherein the scrubbing medium enriched in amine is returned to a regeneration unit.

7. The process according to claim 1, wherein the amine has a partition coefficient log P of not higher than 3.

8. The process according to claim 1, wherein the amine is selected from the group consisting of primary amines, secondary amines, tertiary amines and mixtures thereof.

9. The process according to claim 8, wherein the amine is a cyclic amine.

10. The process according to claim 9, wherein the amine is N,N-dimethylcyclohexylamine (DMCA), N-methylcyclohexylamine (MCA) or a combination thereof.

11. The process according to claim 1, wherein the acid gases are carbon dioxide, hydrogen sulphide or a mixture thereof.

12. The process according to claim 1, wherein the gas stream enriched in acid gases is a biogas.

13. The process according to claim 1, said process further comprising step (c), said step (c) comprising treating the first gas stream depleted in acid gases and in amine in a second scrubbing zone with a second scrubbing medium, wherein the second scrubbing medium is an aqueous medium comprising an amine, the amount of amine comprised by the second scrubbing medium being about 0 to about 6.0 wt. %, to form a second gas stream depleted in acid gases and in amine and a second scrubbing medium enriched in amine.

14. The process according to claim 1, wherein the first and/or the second scrubbing medium enriched in amine are subjected to a separation process.

15. The process according to claim 14, wherein the first and/or the second scrubbing medium enriched in amine is heated to a temperature in the range of about 40° to about 90° C. which results into the formation of an aqueous phase depleted in amine and a non-aqueous phase enriched in amine, where after the two phases are separated.
